(19) United States
(12) Patent Application Publication
(10) Pub. No.: US 2006/0109251 A1
(43) Pub. Date: May 25, 2006

(54) Combined keyboard and movement detection system

(76) Inventor: Jesse Kelly, Philadelphia, PA (US)

Correspondence Address: Norris, McLaughin & Marcus P.A., 18th Floor, 875 Third Avenue, New York, NY, 10022, US

(21) Appl. No.: 11/280,375

(22) Filed: Nov. 16, 2005

Related U.S. Application Data
(60) Provisional application No. 60/629,507, filed on Nov. 19, 2004.

(51) Int. Cl. G09G 5/00

(52) U.S. Cl. 345/168

(57) ABSTRACT

This invention integrates a keyboard and movement detecting means into one device. Accordingly, the present invention provides for a combined keyboard and movement detection system for inputting electronic data. The system comprises a unitary keyboard provided with a plurality of data keys for entering data. The keyboard is sized to allow for data input using two hands placed side by side. At least one means for detecting movement of said keyboard relative to a surface is further provided attached to a side of the keyboard. In another embodiment the combined keyboard and movement detection system comprises a keyboard as above and a plurality of spaced-apart means for detecting the movement of said keyboard attached to said keyboard.

### BACKGROUND OF THE INVENTION

1. Field of the Invention

The present invention relates to a combined keyboard and movement detection system for inputting electronic data.

More particularly, the invention relates to a system which integrates a keyboard and means for movement detection into one device allowing utilization of both text and position data at the same time.

2. Description of the Prior Art

Existing computer or video-game systems often require the input of data using a keyboard and a mouse. The keyboard is usually equipped with a plurality of data keys, which allow entering numbers or letters into an attached electronic device, e.g. a computer. The keyboard is associated with a so-called cursor on an attached screen representing the current typing position. The mouse is a pointing device and allows moving a further cursor or pointer around a display in order to select objects on the display. The mouse is equipment with a number of buttons facilitating the selection of the desired object on the screen or the placement of the keyboard cursor at a desired location. The mouse is usually placed on a surface and is equipped with a movement sensor and transducer measuring the relative movement of the mouse with respect to this surface. This movement is then translated into a movement of the associated mouse pointer on the screen.

Mouse and keyboard are usually two separate, distinct devices. The drawback of these systems is that if a user wishes to select a certain object on a display while typing, he needs to stop typing, place a hand on the mouse, move the mouse to a desired object, activate a mouse button to select that object, and then to return the hand back to the keyboard into the typing position. The same holds for a variety of other pointing devices, like track points, track balls or touch pads, all well known in the art. Such devices are often integrated into the keyboard of a mobile computer, a laptop. While the pointing device in these applications forms an integral part of the keyboard, the user still needs to move his hands to and from the keyboard keys to the pointing device and back. This extra movement of the hand takes time and added effort and often leads to so-called repetitive stress injuries (RSI).

In order to overcome the problems known in the art, U.S. Pat. No. 5,457,480 to White teaches a device in which functions of both a conventional mouse and a numerical data entry keypad are integrated into a single unit, i.e. a numerical keypad is integrated into a mouse housing. A hood is provided to hide the keypad while using the mouse as a pointer. The hood is rotatable between a first position in which the numerical data entry keys are rendered accessible, thereby enabling the device to function as a numerical keypad, and a second position, in which the numerical data entry keys are rendered inaccessible, thereby enabling the device to function as a conventional mouse. However, the size of the device does not allow incorporation of a standard keyboard having both number and letter keys for entering data using both hands of a user placed side by side. Mouse and keyboard function are not accessible simultaneously.

U.S. Pat. No. 6,603,461 to Smith et al. teaches a keyboard that may be utilized as a pointing device for disabled users. The keyboard is provided with buttons which allow toggling of the keyboard between a typing and a pointing state. In a pointing state a movement sensor is activated to detect the movement of the keyboard. The detected movement of the keyboard is then used to control the movement of a cursor about a display screen. The movement sensor forms and integral part of the keyboard and comprises a control stick extending below the keyboard. The reference does not teach a movement sensor placed on a side of the keyboard. Also a plurality of movement sensors is not disclosed. Only a single movement sensor on the bottom surface of the keyboard is provided. The system can not operate in typing and pointing state at the same time. A user still needs to take one hand of the standard typing position in order to switch between the two states of the device.

U.S. Pat. No. 5,936,555 to Zagnoev teaches a combined keyboard and pointing system for use with a computer. The system comprises a keyboard consisting of at least two keyboard parts for generating keying commands. In one embodiment, the standard QWERTY keyboard known in the art is split into at least two parts, one to be gripped by the left hand, one by the right hand. One of those parts includes a movement transducer used to detect movement of the keyboard part relative to a support surface. A palm rest used in conventional keyboard is provided. Another embodiment teaches the use of a unitary keyboard with recesses or gripping surfaces to allow the user to move the keyboard. However, the movement transducer is placed on a bottom surface of the keyboard and not on a side of the keyboard. A plurality of movement transducers is not provided.

U.S. Pat. No. 4,369,439 to Broos teaches a cursor position controller for a display device. A position indicator is moved over a visual display in response to signals generated by corresponding movement of a keyboard relative to a fixed point on the surface supporting the keyboard. Control bars for controlling the operation of electromechanical brakes are attached to a lower lateral edge of the keyboard. An operators palm may rest lightly on the control bars. However, this reference does not teach the use of multiple movement sensors and placement of the position indicator to a side of the keyboard.

U.S. Pat. No. 6,018,334 to Eckerberg teaches a computer pointing device including a supporting member which supports or forms a part of a conventionally-know QWERTY keyboard. The supporting member is movable relative to a supporting surface and includes a sensor for sensing directional movements or directional pressures of the supporting member relative to the supporting surface. For example, a palm rest can be movably coupled relative to a supporting member. The sensor is placed on a bottom surface of the supporting member. A movement detector placed on a side surface is not disclosed. Furthermore, the use of a plurality of movement sensors is not taught.

The above references teach systems having a single movement sensor and transducer only, being integrally formed on the bottom surface of the keyboard. A disadvantage associated with this arrangement is that if a rotational movement of the keyboard is performed and the movement sensor is arranged close to the center of rotation, a large movement will be required to actually move the pointer about the display.

However, a large number of computer tasks involve a vertical or vertical component of a rotational or angular movement of the pointer. For instance, graphical user interfaces (GUI) common to a large number of computer programs often integrate a control bar in a top row of the GUI. In order to select a desired item on the control bar, the pointer needs to be moved upward. A similar downward movement is necessary to select items on a task bar of computer operating systems.

It is therefore an object of the present invention to provide a system for combining a keyboard and movement detecting means which allows utilization of keyboard and position entry at the same time and enhances the vertical movement or vertical component of the position entry, with additional ability for precision and fine-tuning of the movement.

It is a further object of the present invention to provide a system for combining a keyboard and movement detecting means which allows leaving a user's hands in a typing position while changing position of an associated pointer at the same time.

It is yet a further object to provide a system for combining a keyboard and movement detecting means which allows an efficient and easy application of force by the user to achieve movement of the keyboard.

It is a still further object of the invention to provide a system for combining a keyboard and movement detecting means which allows a high degree of control of the system.

It is an additional object of the invention to provide a system for combining a keyboard and movement detecting means which reduces the chances of repetitive stress injury further.

### SUMMARY OF THE INVENTION

This invention integrates a keyboard and movement detecting means into one device. Accordingly, the present invention provides for a combined keyboard and movement detection system for inputting electronic data. The system comprises a unitary keyboard provided with a plurality of data keys for entering data. The keyboard is sized to allow for data input using two hands placed side by side. At least one means for detecting movement of said keyboard relative to a surface is attached to or integral with the keyboard at a side.

In another embodiment the combined keyboard and movement detection system comprises a keyboard as above and a plurality of spaced-apart means for detecting the movement of said keyboard attached to said keyboard.

The system could further comprise at least one moving and support means arranged adjacent a lateral lower edge of the keyboard to allow movement of the keyboard by way of a force of a user's palm or wrist. The palm or wrist is being supported on the moving and support means, which allows movement of the system and simultaneous use of said keys by way of the fingers of the user.

Advantageously, the operator is able to use both the keyboard and mouse while keeping their hands in the keyboard typing position.

A placement of the means for detecting movement to a position off the vertical center line of the keyboard enhances the vertical movement of an associated pointer as will be discussed below.

Multiple movement detectors can enhance the movement of the pointer around a display. Multiple locations allow reading a movement at different locations, whereby any errant movements of a single mouse reader or measurement errors can be canceled out. Additionally, such an embodiment could be used to use multiple locations to each focus on a different type of movement.

The application of a plurality of means for detecting movement increases the control of the pointing device. One means for detecting movement could be located on a side of the keyboard to enhance vertical control while an additional means could also be located on the top to enhance a separate reading of horizontal control.

Time is saved as the user does not need to continually separate a hand from the keyboard to operate a pointing device. The present invention helps to reduce RSI's because a user needs to perform less movement and effort to accomplish the same tasks.

### BRIEF DESCRIPTION OF THE DRAWINGS

FIG. 1 is a schematic drawing of a keyboard and a mouse pointing device known in the art.

FIG. 2 is a schematic drawing of the top view of a preferred first embodiment of the invention.

FIG. 3 is a schematic drawing illustrating the enhanced vertical movement of the means for detecting the movement.

FIG. 4 is a further illustration of the enhanced vertical movement of the means for detecting the movement.

FIG. 5 is a top view of a second embodiment of the invention with a detachable movement detection means attached to the keyboard.

FIG. 6 is a top view of a second embodiment of the invention with a detachable movement detection means detached from the keyboard.

FIG. 7 is a top view of a third embodiment of the invention.

FIG. 8 is a top view of a fourth embodiment of the invention.

FIG. 9 is a bottom view of a fifth embodiment of the invention.

FIG. 10 is a top view of another embodiment of the invention provided with a base.

FIG. 11 is a bottom view of the embodiment presented in FIG. 9.

FIGS. 12 and 13 are schematic drawings of other embodiment of the base of FIG. 9.

### DETAILED DESCRIPTION OF THE INVENTION

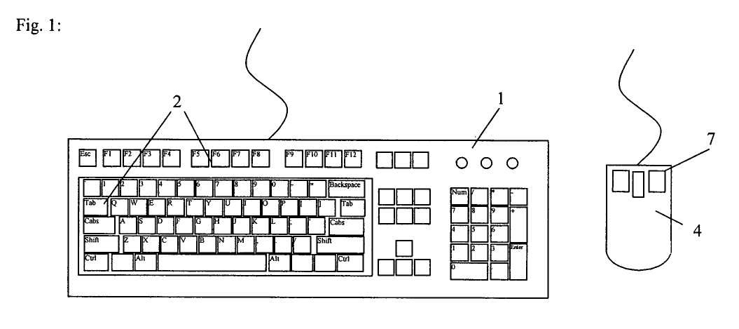

FIG. 1 shows a standard keyboard 1 and a standard means for detecting movement 4, a mouse pointing device, known in the art. Both can be connected to an electronic device, such as a computer and monitor, via a cable or a wireless connection. A keyboard 1 is a typing device. Keyboards 1 are designed for the input of text and characters, and also to control the operation of electronic devices like computers. Physically, keyboards 1 are an arrangement of rectangular or near-rectangular buttons, or “keys” 2. Keyboards 1 typically have characters engraved or printed on the keys 2; in most cases, each press of a key 2 corresponds to a single written symbol. In the computer or electronic media environment the keyboard is usually associated with a cursor on a display. The cursor is a solid or transparent rectangle indicating the position of the next insertable character.

A mouse is a handheld pointing device or means for detecting movement 4 used for computers. It is usually equipped with one or more buttons 7 and shaped to sit under a user's palm. The mouse houses a device that detects its motion relative to a flat surface, which is translated into the motion of a pointer on a display, e.g. a computer monitor. An optical mouse uses LED's or laser paired with an optical sensor to detect movement. In a mechanical mouse usually a ball is rolled on a surface and its movement is translated into the movement of an additional second cursor or pointer on the screen. Also known are mice which sense movement gyroscopically without reference to a surface. All such movement detecting devices may be incorporated into the present invention. The pointer moves in a direction and amount corresponding to the movement of the mouse. An entry is selected by pointing the cursor at the display location defining that entry and pressing a button on the mouse.

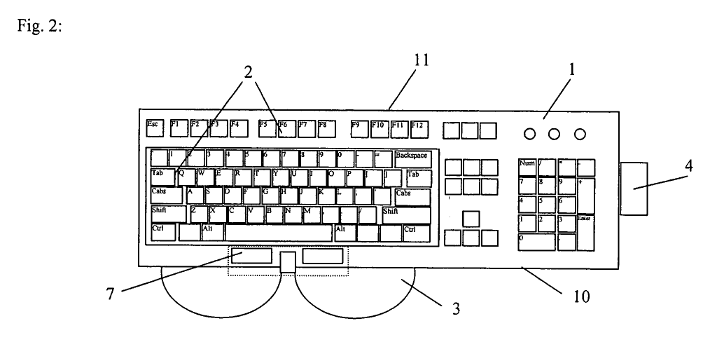

The present invention integrates the keyboard and pointing device functions into a single system. The system as shown in FIG. 2 comprises a unitary keyboard 1, provided with a plurality of keys 2. The keyboard 1 is sized to allow for data input using both hands of a user placed side by side. Preferably the keyboard 1 is provided with a standard QWERTY keyboard layout, known in the art. The system further comprises at least one means for detecting movement of said keyboard 4. In the preferred embodiment, the means for detecting movement 4 is located off-center position of the keyboard, preferably off the vertical center line of the keyboard, and even more preferably to the side of the keyboard, such as being attached to a side of the keyboard 1. Means for detecting movement 4 comprises a movement sensor and transducer and means for communicating the movement of the keyboard. The communication between the system and an attached electronic device, e.g. a computer, a TV, or a game console, can be facilitated via a cable or wirelessly. The movement sensor and transducer can be realized as a rotatable ball, a track pointer, an optical laser device or any other form known in the art. Means 4 can form an integral part of the keyboard 1 or both can form modular, separable parts.

In one embodiment, the system could further comprise at least one moving and support means 3 arranged adjacent a lateral lower edge 10 of the keyboard 1 to allow movement of the keyboard 1. A user's palm or wrist is supportable on the moving and support means 3 in such a way that a combination of forces via the palms or wrists on the means 3 in directions both perpendicular and coplanar with the plane of the keyboard 1, allow for movement of the keyboard 1 while allowing all the fingers to remain free for data input. The moving and support means 3 forms either an integral part of the keyboard or is detachably connected to the keyboard. One single moving and support means 3 extending along the lower lateral edge 10 of the keyboard 1, or two, e.g. one for each palm or wrist, or more separate moving and support means 3 can be applied.

The system is used in the following way. Keyboard 1 is placed on a support surface, e.g., a table. While the user writes text using the keyboard keys 2, his palms, wrists or forearms rest on the moving and support means 3. If the user now wishes to select a certain object on an associated display using the pointer function he applies a force on the moving and support means 3. Since means 3 is connected to the keyboard 1, the keyboard 1 moves upon the support surface. Means for detecting the movement 4 now detects the movement of the keyboard 1, which is consequently translated, preferably by using software, into a movement of the pointer on a display. Such software is known in the art. However, the force could also be applied through a user's fingers or palms. For instance, a force could be applied to the lower lateral edge 10 of the keyboard 1 through the user's palms resting thereon. The keys could be provided with contours to allow movement of the keyboard 1 using the finger tips.

In accordance with the embodiment of the invention, both keyboard I and pointing device are combined into one device. The pointing device is integrated into the keyboard 1 and the whole keyboard 1 slides around a support surface in the same way as a conventional pointing device, such as a mouse. Users can retain their hands in typing position while the keyboard 1 is moved. The user does not have to move a hand to a separate device or leave the keyboard typing position. The system allows controlling the mouse input with two hands, or alternatively the user can operate the system with one hand at a time.

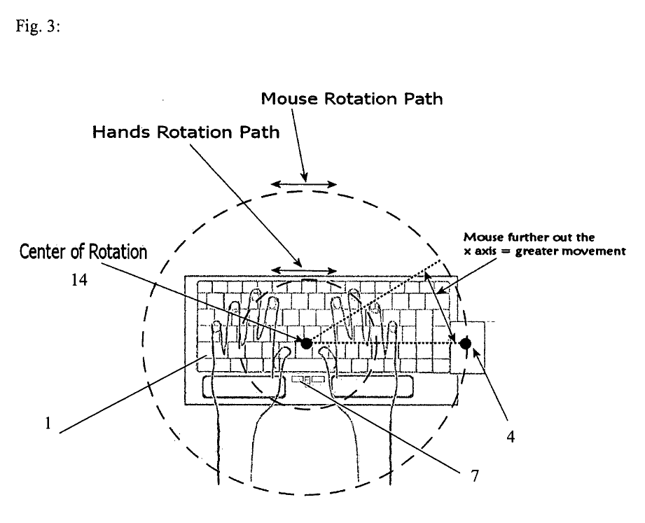

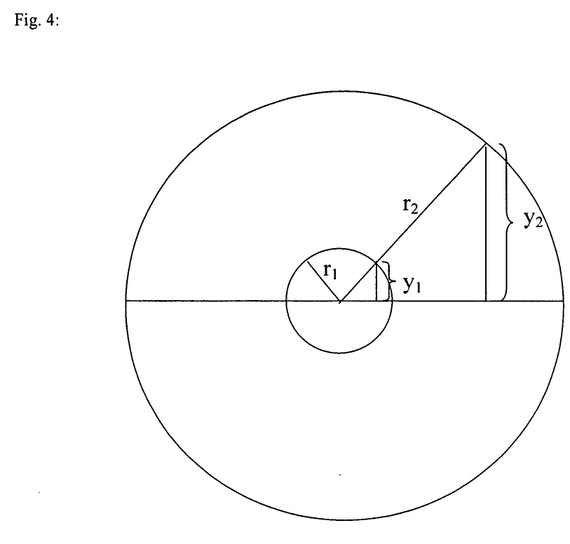

The placement of the means for detecting a movement 4 on a side of the keyboard enhances the vertical movement of the means 4 and the associated pointer about a display. The enhanced motion is utilized by a gentle rotation of the hands as illustrated in FIGS. 3 and 4. A user's hands are placed on the keyboard 1 in a typing position. The hands fulfill a rotational motion, i.e. one hand moves up, one hand moves down, whereby the center of rotation 14 is located between the two hands. In a standard QWERTY keyboard such center of rotation could be located, for example, between the letter keys G and H, or just below the spacebar, depending on the individual. While the user's hands only rotate on a first, small circle with a radius r₁, the means for detecting movement 4 attached to a side of said keyboard 1 moves on a circle having a larger radius r₂. Whereas the hands move upward only by a length y₁, the means for detecting movement 4 moves upward by a length y₂ greater than y₁. Thus, by positioning the means for detecting movement 4 on a side of the keyboard 1, the vertical movement of the means 4 is enhanced in comparison to the actual movement of the hands. Consequently, the movement of a pointer on a display associated with means 4 is enhanced.

As an example of the enhanced movement a keyboard 1 having a length of 45 cm is considered. The distance r₂ of the means 4 attached to a right side of the keyboard 1 to a center of rotation located between the letter keys G and H is approximately 30 cm. If the user's fingers are arranged in a typing position, wherein the left hand fingers would type the letter keys “A”, “S”, “D”, “F” and the right hand fingers the keys “J”, “K”, “L”, and “;”, the radius r₁ of the hands rotation path has a size between 4 and 6 cm, say 5 cm. Thus, the radius of the means for movement detection 4 is six times larger than the radius of the hands. Correspondingly, the associated vertical movement of the means 4 is enhanced by a factor 6 in comparison to the actual movement the user's needs to fulfill.

Note, if a standard QWERTY computer keyboard 1 is used, it is preferred to locate the means for detecting movement 4 to a right side of the keyboard, since the center of the letter keys 2 of a standard keyboard 1 is shifted to the left of the keyboard center point. In the above example, placing the means 4 to a left side of the keyboard would enhance the movement by a factor of 3, since the distance r₂ of the means 4 attached to a left side of the keyboard 1 to a center of rotation located between the letter keys G and H is approximately 15 cm. However, if a keyboard 1 is used, which has a layout, wherein the center of the letter keys and the center of the keyboard correspond to each other, the left and right sides are equally preferred.

In a combined keyboard and movement detection system known in the art the means for detecting movement 4 are arranged on a bottom surface of a keyboard 1, e.g. in the center of the bottom surface. If the location of the means for detecting movement 4 corresponds to the center of rotation 14, no movement at all is detected. If the means for detecting movement 4 is arranged within the circle associated formed by the rotation of the hands, the vertical movement of the means 4 in comparison to the actual vertical movement of the hands is smaller. With such arrangement an enhanced vertical movement can not be achieved to the same degree as presented in the present invention.

In general, the side placement decreases the movements the user of a standard keyboard has to make while at the same time offering a more enhanced and intuitive control of the pointing device, since both hands can be employed in the movement in comparison to a standard pointing device, like a computer mouse. This is even more important, since a standard keyboard 1 has a higher weight in comparison to a standard mouse pointing device.

Placing the means for detecting movement 4 on the sides enhances vertical control when turning the hands in a complementary rotational movement, somewhat like the control of a steering wheel, though not limited necessarily to a circular motion. This is the preferred method, as many dialog boxes with drop down menus on a computer have more need for vertical pointer movement. This could further be enhanced by placing means 4 at a corner of keyboard 1, since such positioning increases the distance to a center of rotation 14 even further, thus providing an optimal enhancement of the vertical motion. For computer game applications, the ‘steering wheel’ action of the keyboard can be of advantage, e.g. in virtual reality computer programs or simulations of car races. The present invention is also useful for 3D drawing using CAD.

Since the movement of the keyboard 1 is facilitated by using both hands of a user, a superior control and fine tuning of the position is obtained in comparison to a standard mouse, which is moved only by a single hand. However, the movement can also be achieved by using a single hand, if preferred.

In the exemplary embodiment, the system can be provided with means for slidably supporting said keyboard 6 and forming a low friction contact between the keyboard 1 and the support surface. This can be accomplished in many different ways, including bearings, ball transfers, sliding, rolling and gliding materials, wheels, magnets, fabrics, metal, liquids, gels, polishes, special surfaces like Teflon®, special textured surfaces, air, and more. The means 6 can be attached to the keyboard 1 or directly placed on a support surface of keyboard 1.

As seen in FIG. 2, mouse input devices 7, e.g. comprising two buttons and a scroll wheel, can be arranged adjacent a lower edge 10 of the keyboard 1. The mouse input devices 7 can form an integral part of the keyboard 1 but can also be secured detachably on the keyboard 1. Mouse buttons and wheel can be placed near the keyboard space bar allowing either thumb to perform mouse button actions. Mouse input devices 7 can also be located anywhere else on the keyboard 1 or off the keyboard 1, or controlled by feet or arms or other ways.

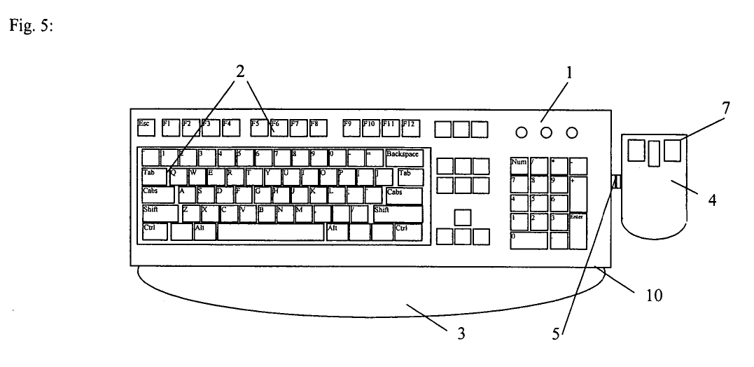

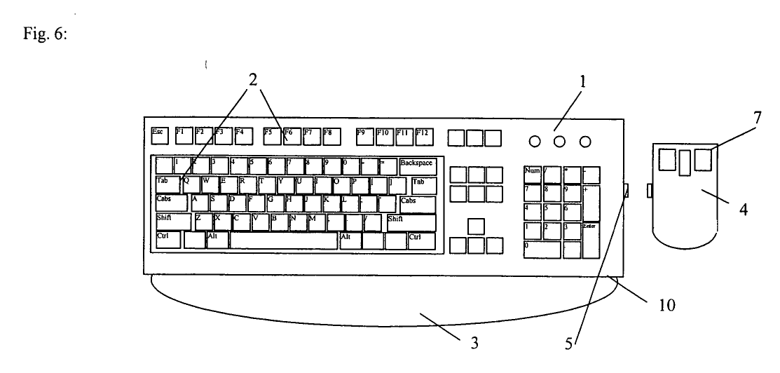

FIGS. 5 and 6 show a top view of a second embodiment of the invention. In this embodiment the means for detecting movement 4 is secured detachably to the keyboard 1 by attachment means 5. Said means 5 comprises magnets, hook and loop fasteners, clips, or may be any known mechanism for detachably securing two surfaces. Advantageously, this embodiment allows using a conventional mouse as the means for detecting movement 4 with mouse input buttons 7. A magnet is fixed, e.g. by using a strong adhesive, to the pointing device at a side facing the keyboard 1. Another magnet with opposite polarity is attached to the keyboard 1. Both magnets in conjunction connect the mouse to the keyboard 1. Keyboard 1 is then utilized as described above. At any time the user is able to detach movement detecting means 4 again and use it in the conventional way as shown in FIG. 6. This embodiment allows using a standard keyboard 1 and a standard mouse 4 in order to achieve the advantages of the present invention. The movement detecting means 4 is connected to a side of the keyboard. The advantages of a side placement have already been addressed.

FIGS. 5 and 6 also show an alternative embodiment of the moving and support means 3. Here, moving and support means 3 is provided by a single pad extending along a considerable part of the lower lateral edge 10 of the keyboard 1, allowing the user to rest his palms or wrists on said moving and support means 3 wherever he is currently typing on the keyboard 1. This embodiment distributes the force more equally along the keyboard 1 thus enabling easier upward lateral movement of the keyboard 1 and the associated pointer without rotation.

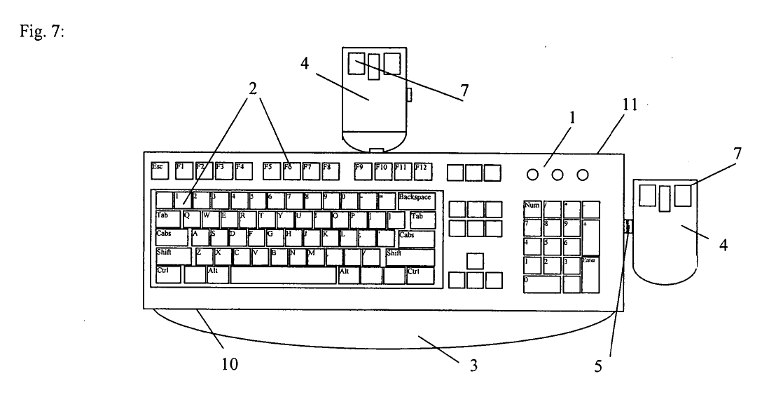

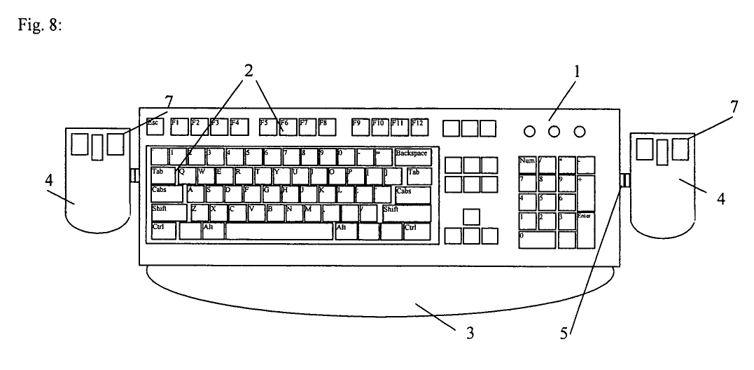

FIGS. 7 and 8 are top views of a fourth embodiment of the invention. Two means for detecting a movement 4 are attached to either side of the keyboard 1 (FIG. 8). However, they could also be attached to the upper lateral edge 11 or lower lateral edge 10 of the keyboard 1 (FIG. 7). Also, more than two means 4 can be connected to the keyboard 1. Software could be provided to use the information from both means 4 to move the associated pointer around a display. Wherein the positioning of the means 4 at a side of the keyboard 1 enhances vertical movement, the location on the top and/or lower lateral edge 10 and 11 increases a horizontal movement in a similar way as the vertical movement is enhanced by a side placement. Thus, movement in both lateral directions can be improved by the system according to the present invention as shown in FIG. 7. This is especially useful for some languages and cultures, or certain software tasks, where reading and writing takes place in vertical columns arranged horizontally adjacent to each other. Positioning of the mouse at the top or bottom will enhance the horizontal movement.

Multiple means for detecting movement 4 enhance the movement of the pointer around a display, especially on reflective surfaces where optical laser readers can have problems, or on polished surfaces, where a single ball type reader might lead to failure. Multiple locations allow reading the movement at different locations, whereby any errant movements of a single mouse reader or measurement errors can be canceled out or compensated for. Furthermore, during a rotational motion of the keyboard, that means for detecting a movement 4 closest to a center of rotation would move only slightly, while the one furthest away from the center would move a much greater distance. Averaging those movements or otherwise combining data therefrom, e.g. by using software, would result in an optimal motion of the pointer on a display. One means for detecting movement 4 could be located on a side of the keyboard to enhance vertical control while an additional means 4 could be located on the top to enhance a separate reading of horizontal control.

The system can be provided with a combination of one or more of moving and support means 3, attachment means 5 and means 6 for slidably supporting said keyboard in all their variations as discussed previously. Means for detecting movements 4 can form an integral part of the keyboard 1, or the keyboard 1 and means 4 can be provided as modular, separable parts.

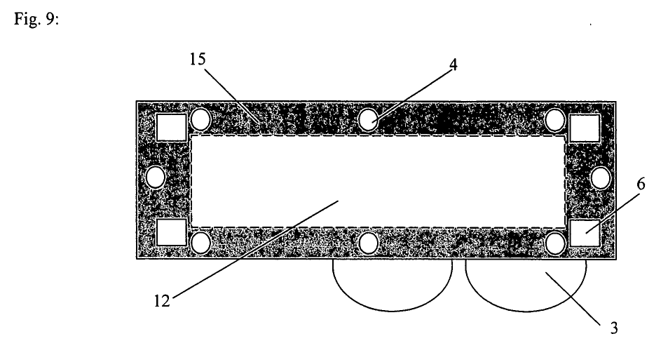

FIG. 9 is a bottom view of a fifth embodiment of the invention. The keyboard 1 is provided with a plurality of spaced-apart means for detecting the movement of said keyboard 4. The means 4 are located on a bottom-surface 12 of said keyboard 1. Preferably, means 4 are arranged within an outer peripheral 15 of the keyboard 1 to ensure vertical and horizontal enhancement. The outer peripheral 15 covers at maximum ⅓ of the bottom surface 12 of the keyboard 1. Preferably the outer peripheral 15 covers at maximum ¼ of the bottom surface 12.

In order to provide additional gripping, the keys of the keyboard in this and any previous embodiment can be provided with a tactile material on their top. Additionally, the spacing of the rows of the keyboard 1 can be such to allow placement of the user's fingertips therein, whereby pressure on the keyboard 1 is applicable helping to move the keyboard 1. The spacing of the rows can range from 0.55 to 1.55 cm, preferably from 0.75 to 0.95 cm.

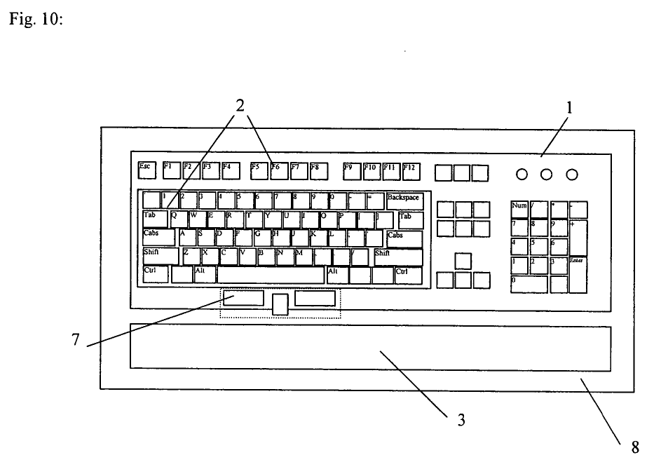

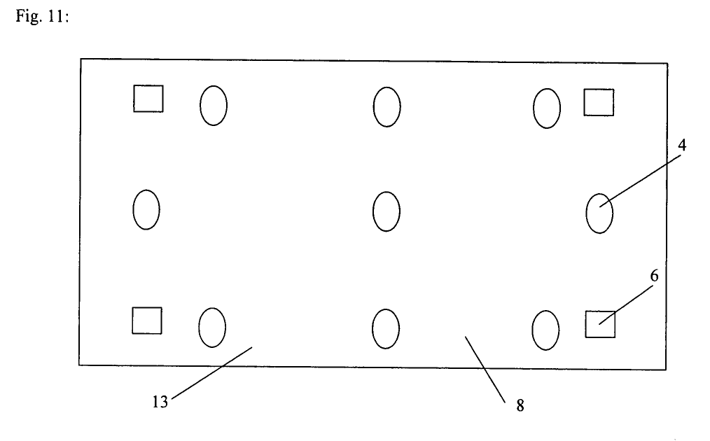

FIG. 10 shows a top view of another embodiment of the invention. The movement detection means 4 further comprises a base or platform 8 on which the system is placed. A plurality of means for detecting a movement 4 and means 6 for slidably supporting are attached to the bottom surface 13 of base 8 as shown in FIG. 11. The base 8 can be provided with movement means 3 connected to its top side. This embodiment allows placement of a keyboard 1 onto the base 8 which is then moved around, i.e. the base 8 replaces the function of the mouse. All different embodiments of the means for detecting movement 4, means for slidably supporting keyboard 1 as previously discussed apply. The embodiment allows for an economical utilization of a standard keyboard as a pointing device.

In yet another embodiment the base 8 is fixed, and the keyboard 1 moves on top of the base 8. The base 8 would act like a track point control used in mobile computer applications, or a joystick control. Pressure in any direction on the keyboard would translate into pointer movement about a display. The base 8 could be provided as a track pad. The moveable keyboard 1 could physically move to translate cursor/pointer movement.

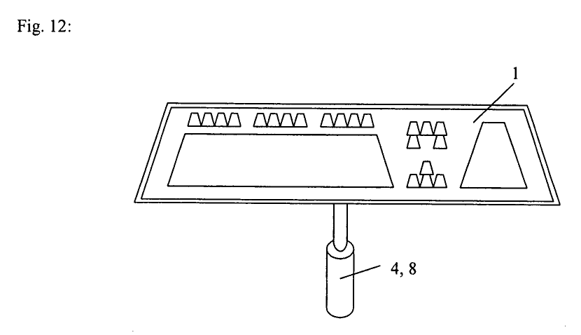

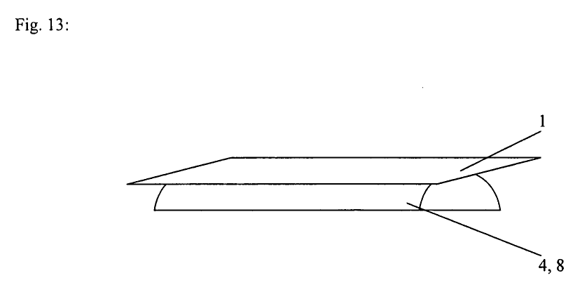

FIGS. 12 and 13 show further embodiments of the invention. A base 8 is provided as a stand in FIG. 12. Centering the cursor on the screen could be incorporated by software. For instance, when no pressure is applied to the keyboard 1, the cursor is centered. The keyboard 1 has a rotational spring which is biased towards a center, while allowing for a gentle push or pull to move the cursor to a desired location. Letting the base 8 go would return the cursor or pointer to the center.

The system could also be placed on a rocker mechanism as shown in FIG. 13, which could enhance control for users in many programs. A rocking motion or pivoting, or even a vertical reading mechanism, could be utilized to allow reading the mouse in three dimensions. This would, e.g., enhance the control of computer games, where game play takes place in a virtual 3 dimensional space.

In all embodiments the keyboard is preferably provided with a standard QWERTY keyboard layout known in the art.

Specific embodiments of the present invention are shown by way of example while the invention is susceptible to various modifications. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the appended claims.

What is claimed is:

1. A combined keyboard and movement detection system for inputting electronic data, comprising:
a unitary keyboard provided with a plurality of data keys for entering data, wherein the keyboard is sized to allow for data input using two hands placed side by side,
at least one means for detecting movement of said keyboard relative to a surface, wherein said means for detecting movement is attached to or integral with the keyboard at a location off the vertical center line of the keyboard.

2. A system according to claim 1, wherein the system further comprises at least one attachment means for attachment and detachment of said at least one means for detecting movement to a side of said keyboard.

3. A system according to claim 2, wherein the attachment means comprises one or more of the group consisting of magnets and hook and loop connectors attached to at least one of the group consisting of the keyboard and the means for detecting movement.

4. A system according to claim 1, wherein the means for detecting movement is attached to a right side of the keyboard.

5. A system according to claim 1, wherein said at least one means for detecting movement is provided by a computer mouse.

6. A system according to claim 1, wherein said at least one means for detecting movement is integrated into the keyboard.

7. A system according to claim 1, further comprising at least one moving and support means arranged adjacent a lateral lower edge of the keyboard to allow movement of the keyboard by way of a force of a user's palm or wrist being supported thereon and simultaneous use of said keys by way of the fingers of the user.

8. A system according to claim 1, wherein the system further comprises means for detecting movement attached to a top lateral edge or lower lateral edge of the keyboard.

9. A combined keyboard and movement detection system comprising:
a keyboard provided. with a plurality of data keys for entering data, wherein the keyboard is sized to allow for data input using two hands placed side by side,
a plurality of spaced-apart means for detecting the movement of said keyboard attached to said keyboard.

10. The system according to claim 9, wherein the plurality of means for detecting movement of said keyboard comprises means for detecting movement attached to a side of said keyboard.

11. The system according to claim 9, wherein the plurality of means for detecting the movement comprises means for detecting movement attached to a top or lower lateral edge of the keyboard.

12. The system according to claim 9, wherein the plurality of means for detecting the movement comprises means for detecting movement attached to a bottom surface of the keyboard.

13. The system according to claim 9, further comprising at least one moving and support means arranged adjacent a lateral lower edge of the keyboard to allow movement of the keyboard by way of a force of a user's palm or wrist being supported thereon and simultaneous use of said keys by way of the fingers of the user.

14. The system according to claim 9, wherein the plurality of means for detecting the movement comprises means for detecting movement attached to a top or lower lateral edge of the keyboard.

15. The system according to claim 9, further comprising software means for calculating the movement of the keyboard based on the information from the plurality of movement detection means.

16. A system according to claim 9, wherein the system further comprises at least one attachment means for attachment and detachment of said means for detecting movement to the keyboard.

17. A system according to claim 16, wherein the attachment means comprises one or more of the group consisting of magnets and hook and loop connectors attached to at least one of the group consisting of the keyboard and the means for detecting movement.

18. A system according to claim 9, wherein said movement detecting means is provided by a plurality of computer mice attached to the sides of said keyboard.

19. A system according to claim 9, wherein said movement detecting means is integrated into said keyboard.

20. A method of achieving an enhanced vertical movement or movement of a vertical component of a rotational movement of a movement detecting means of the system of claim 1, comprising the steps of:
placing the user's fingers in a typing position on the keyboard of the system, and
performing a rotational motion of the hands,
whereby one hand moves rotationally upward, while the other hand moves rotationally downward.
